(19) United States
(12) Patent Application Publication
(10) Pub. No.: US 2004/0128348 A1
(43) Pub. Date: Jul. 1, 2004

(54) Control and communication methods

(76) Inventors: Martyn Gilbert, Longstanton (GB); Andrew Christopher Dean, Hadderham (GB)

Correspondence Address: Lawrence G. Fridman, Esq., SILBER & FRIDMAN, ESQS., 66 Mount Prospect Ave., Clifton, NJ, 07013-1918, US

(21) Appl. No.: 10/624,122

(22) Filed: Jul. 21, 2003

(30) Foreign Application Priority Data
Feb. 9, 2001 (GB) 0103289.5

(51) Int. Cl. G06F 15/16

(52) U.S. Cl. 709/203; 715/513

(57) ABSTRACT

A browser program which, when executed by a suitable device, causes the device to carry out the method steps of:

examining data received as a page comprising page data and mark up language tags and identifying the mark up language tags;

analysing the identified tags to derive instructions; generating a visual output derived from the page data based on instructions derived from the identified tags; and carrying out further operations based on instructions derived from the identified tags and not derived from the page data.

This invention relates to control and communication methods and particularly to methods for communication with and remote control of remote devices by a server across a network such as the Internet and a browser for carrying out the methods.

The normal method by which information is transmitted across the Internet is by HTML (Hypertext markup language) “pages” being made available on a server. When remote devices, typically computers, access and download the HTML pages on the server a software program called a browser running on the accessing computer interprets the electronic data making up the page and causes graphical and textual elements to be displayed on a screen and audio signals to be produced in response to HTML commands associated with the HTML page.

Typically the graphical and textural elements are displayed on a computer monitor or television screen while the audio output is emitted from computer or television speakers.

Thus, the known methods of delivering data in the form of pages across the Internet using HTML produce the digital data making up the page as a visual display and audio output with the appropriate procedures for converting the digital data into visual and audio output being defined by the markup language commands associated with the page. The markup language commands are generally referred to as tags.

It is currently proposed to replace HTML pages with an enhanced page format known XML, (extended markup language). This will provide pages able to be delivered across the Internet operating in a similar way to the HTML pages described above but having a greater range of available tags in order to allow more scope for the display of digital data in visual and audio form and so allow more services to be provided across the Internet.

Thus, where digital data is provided in the form of HTML or XML pages through the Internet the audio or visual form in which the data is presented is controlled by the commands contained in the HTML or XML tags.

Thus, conventional browsers and markup language tags are only able to control the form in which the data carried out the tagged page is reproduced. However, there are many applications in which it is desirable or essential to transmit further instructions or information. However, such further instructions or information cannot be carried by conventional web pages and must be transmitted by a separate communications route.

The present invention is intended to overcome this problem at least in part.

The first aspect of this invention provides a browser program which, when executed by a suitable device, causes the device to carry out the method steps of:

examining data received as a page comprising page data and mark up language tags and identifying the mark up language tags;

analysing the identified tags to derive instructions; generating a visual output derived from the page data based on instructions derived from the identified tags; and carrying out further operations based on instructions derived from the identified tags and not derived from the page data.

Further, in a second aspect this invention provides tags suitable for incorporation into web pages and able to provide instructions to carry out the further operations to browsers.

The present invention employs new markup language tags which instruct a browser able to interpret the tags to carry out functions beyond the known functions of defining the form in which digital data contained within a page should be displayed carried out by conventional HTML or XML tags.

In typical applications where pages of data defining graphical or video display items are accessed across the Internet the HTML pages are received and interpreted by a software browser running on a local access and display device such as a PC, digital television or digital set top box providing data for display on an associated television.

Typically the access device on which the browser runs consists of a number of functional hardware and software sections. The browser runs on one of these sections and this section may also incorporate or support hardware or software having video or graphics capabilities or able to implement visual special effects. The browser may be able to use these video graphics or special effects capabilities in processing and displaying the data received from a web page and the video graphics and special effects capabilities to be employed will be defined to the browser by appropriate conventional HTML tags associated with the HTML page.

The access device on which the browser is running, may also include hardware peripheral devices. Each such hardware peripheral device will have a software device driver interacting with the device hardware and exposing an interface to allow other parts of the access device to access the peripheral.

Similarly, the access device on which the browser runs may also be connected to remote peripherals, that is discrete devices to which the access device can be connected to allow messages to be sent to the peripheral device from the device on which the browser runs and to allow responses to be received from the remote peripheral. Such connection may be a wired or a wireless connection.

A first class of functions which can be carried out using the invention is to control attributes of the environment within which a graphical or video display derived from digital data provided through a web page is displayed.

Where the digital data on a web page made available over the Internet is to be displayed in a graphical or video form the conventional HTML tags will define the way in which the digital data from the page is to be interpreted to produce a graphical or video display within a window on a display device. However, the size of the window within which the graphic or video display is to be presented and the elements displayed outside this window such as the browser icon, borders or toolbar are determined by the browser and other software operating in the access device accessing and displaying the data from the web page and are not set by the web page or under the control of the provider of the web page.

Using the present invention, new markup language tags can be provided which are interpreted by the browser according to the invention to control the size of the display window for the graphical or video display and/or to control what is to be displayed outside this window.

For example, the novel markup language tags could instruct the browser according to the invention to carry out full screen display of graphical or video images, to overlay a formatted HTML page on a video display or to hide browser “furniture” such as borders or a toolbar or the browser icon itself so that only the displayed graphical or video images derived from the HTML page data are visible.

The provision of a full screen display is particularly useful in applications where a web page provides streaming unicast or multicast video images for display.

Other possible functions of the new markup language tags according to the invention would be to instruct the browser according to the invention to control foreground and background alpha blending values between foreground visual items derived from the web page digital data and background items locally generated by the host access device running the browser software and vice versa.

A second class of functions which can be carried out using the invention is that a browser can be instructed by novel tags to communicate with and control sections of the access device other than the section running the browser, hardware peripheral devices and remote peripheral devices. This cannot be done using conventional HTML/XML tags.

In order to do this the browser according to the invention must be able to access the elements to be controlled which may be other sections of the access device, peripherals of the access device or remote peripherals with which the access device can communicate. The tags according to the invention controlling interaction of the browser according to the invention with other sections of the access device, peripheral devices and remote peripherals cannot in themselves give the browser the capability to communicate with otherwise inaccessible peripheral devices and remote peripherals. It is necessary for the browser according to the invention to be able to carry out such communications and for the necessary physical data links to be present.

Preferably, when the browser according to the invention starts up the browser establishes a channel of communication with each of the other functional sections, parts or peripheral devices of the access device on which the browser is running to which the browser may require access and establishes a channel of communication to each remote peripheral to which the browser may require access. These channels of communication may be through internal communications links within the access device on which the browser is running to other sections of or peripheral devices of the access device or may be through external links or networks to remote peripherals and may be established over any suitable physical communications link including both wired and wireless communications links and networks.

When the functional sections or devices contacted by the browser have replied the browser can then proceed to remotely activate the software device driver or software packages of the functional section, peripheral device or remote peripheral in order to enable the functions to which the browser requires access when necessary.

This establishment of channels of communication is preferably carried out immediately the browser starts running. Alternatively, the channels of communications with other functional sections, peripheral devices or remote peripherals can be opened in response to identification of an HTML tag requiring access to the functional section, peripheral device or remote peripheral.

The establishment of a channel of communication can be carried out at either of the times identified above or at any intermediate time as convenient or required in a particular implementation. The best time to establish such communications links in a specific implementation may depend upon the precise nature of the other functional sections, peripheral devices or remote peripherals and the nature of the available communications links as well as on the detailed implementation of the browser and tags according to the invention.

When a required channel communication has been opened and the operation of the channel communication has been confirmed some initial access to the other functional section, peripheral device or remote peripheral may be carried out by the browser. For example, where a peripheral remote device having an LCD display is being controlled by the browser the browser could instruct the remote peripheral device to display a startup message on the LCD display. Such display of startup messages or other indications that remote peripherals have been contacted and are ready to function can provide reassurance to users that all of the necessary peripheral devices are connected and operational. Failure of the expected startup messages or readiness indications to appear may be useful to allow a user to identify remote peripheral devices which are not properly connected to the access device running the browser or non-functioning for some other reason such as not being connected to a power supply. Further, where the required functional sections, peripheral devices or remote peripherals require time to become fully functional after activation, for example because internal software must be accessed, loaded and tested the initial access can be used to bring these elements into a fully functioning condition in good time before they are required.

Whenever the browser according to the invention loads an HTML document or page containing the new tags according to the invention the browser passes the attributes associated with the tags and then makes appropriate calls to the required functional sections of the access device, hardware peripheral software devices, driver interfaces or remote peripheral devices.

One function which could be carried out in this way would be for a mark up language tag according to the invention to contain attributes specifying what text should be displayed on an LCD or other text display of a remote peripheral device. For example where a video display is provided to a set top box through a web page the tag could specify a corresponding text identifying the video program content or the cost of viewing the content on a pay-perview basis to be displayed on an LCD display of a user remote control. In this case the instructions to display the text and the text to be displayed could be passed from the set top box to the remote control device by a wireless communications link such as an infrared link.

In this example the tag according to the invention specifying the text to be displayed could be a code allowing the required text to be called up from a library of possible texts stored in the access device or could set out the text to be displayed in full. Alternatively a combination of the two could be used where part of the text to be displayed is called up from a locally stored library of texts and part of the text is encoded within the tag.

Another example of use of the invention is that the access device may have a smart card reader associated with it as a peripheral device or remote peripheral device with the smart card reader being used to authorise or pay for access to data, typically video and audio data, through a web page.

In this case the tag according to the invention can instruct the browser to request the smart card reader to carry out a transaction with the smart card based on information contained in the tag. The instructed transaction between the smart card reader and smart card could have a number of effects. Typically where the data provided through the web page is a video signal for which access is to be restricted such as a pay-per-view program or subscription only channel an authorising signal or decryption password obtained by the smart card reader from the smart card is required by the access device in order to allow the signal to be decrypted by the browser or associated decryption and display elements to allow the signal to be properly displayed. In this example the interaction between the smart card reader and the smart card instructed by the browser will produce the necessary authorising or decrypting code for the signal to be displayed. When the signal is provided on a pay-per-view basis the transaction between the smart card reader and the smart card may also cause an available credit value stored on the smart card to be reduced.

The tags and browser according to the invention can also be used in highly asymmetric networked systems in order to allow a greater degree of apparent interaction to be perceived by the user than can actually be supported by the communications network. This invention can even be used in systems where data and transmission occurs only from the server to the user so that no actual interaction is possible to provide the illusion of interaction between the user and the service provider. Such pseudo interaction can greatly enhance the users enjoyment and appreciation of a service because the service provided can appear to be more responsive, personal and specific to the user.

Pseudo interaction can be provided in a highly asymmetric networked system where the rate of data delivery, that is band width, is very much greater from the central server providing the service to the user access device than in the opposite direction or where there is no data capacity at all between the user access device and the central server, for example where a central server provides services through a satellite link. In the asymmetric arrangements the tags according to the invention can be used to instruct the browser to activate stored sequences of actions carried out locally on the users access device and associated peripheral devices and remote peripherals to provide an illusion of interactivity to the user.

Another function which can be provided using the tags and browser according to the invention would be where the user access device is a digital television set top box having an associated remote control. In this case the tags according to the invention can be used to cause messages to be displayed on the remote control such as advertising messages, voting options etc. which can be selected from an available range of the messages so that the messages displayed are tailored to or even unique to a specific user.

XML is an enhanced markup language providing all of the features of HTML and further features. Accordingly, references to HTML in the description will also apply to XML.

The tags and browser according to the invention could be used for transmission of data in the form of pages across any network, but it is expected that it will be most useful for the transmission of data across the Internet.

The embodiments and uses for the tags and browser according to the invention described above are given by way of example only and the person skilled in the art will be able to identify other functions and usages which can be provided by the claimed invention.

1. A browser program which, when executed by a suitable device, causes the device to carry out the method steps of:
examining data received as a page comprising page data and mark up language tags and identifying the mark up language tags;
analysing the identified tags to derive instructions; generating a visual output derived from the page data based on instructions derived from the identified tags; and carrying out further operations based on instructions derived from the identified tags and not derived from the page data.

2. A browser program according to claim 1, in which the visual output derived from the page data is suitable for display in a display region of a visual display unit and the further operations define the size of the display region or elements to be displayed on the visual display unit outside or overlaying the display region.

3. A browser program according to claim 1, in which the visual output derived from the page data can be generated by one or more functional sections of the device and the other operations include sending instructions to other functional sections of the device or to other devices.

4. A browser program according to claim 3 in which the other operations include the display of text identified by the tags.

5. A browser program according to claim 3 in which the other operations include the display of text derived from the tags.

6. A browser program according to claim 1 in which the other operations include requesting a smart card reader to carry out a transaction with a smart card.

7. A browser program according to claim 1 in which the other operations include the device requesting and responding to user commands.

8. A browser program according to claim 1 in which the page is a web page suitable for transmission through the Internet.

9. A markup language tag which can be associated with page data to form a page and adapted to cause a suitable browser program to carry out the method of any preceding claim.

10. A page incorporating a markup language tag according to claim 9.

11. A page according to claim 10, in which the page is a web page.
